(19) United States
(12) Patent Application Publication
(10) Pub. No.: US 2011/0082844 A1
(43) Pub. Date: Apr. 7, 2011

(54) Method and apparatus of correcting chemical names

(75) Inventors: Shenghua Bao, Beijing (CN); Ben Fei, Beijing (CN); Zhong Su, Beijing (CN); Xian Wu, Beijing (CN); Li Zhang, Beijing (CN); Xiao Xun Zhang, Beijing (CN)

(73) Assignee: International Business Machines Corporation, Armonk, NY (US)

(21) Appl. No.: 12/924,541

(22) Filed: Sep. 29, 2010

(30) Foreign Application Priority Data
Sep. 29, 2009 (CN) 200910175703.7

(51) Int. Cl. G06F 17/30

(52) U.S. Cl. 707/697; 707/E17.007

(57) ABSTRACT

A computer-implemented method and system for checking a chemical name. The method tokenizes the chemical name to obtain corresponding tokens; checks the chemical name according to the chemical association between chemical compositions represented by the tokens; and if the chemical name does not pass the check, replaces at least part of tokens of the chemical name that does not pass the check, and repeats the checking step. The system and method can not only help users to find and correct errors in spelling a chemical name but also check the entire chemical name at the level of chemical associations. Hence, not only chemical names that are incorrectly spelled but also ones that do not conform to chemical rules can be found, and significant help is provided to users for correcting chemical names.

### TECHNICAL FIELD

The present invention generally relates to the technical field of information processing and, more particularly, to a method and system for checking chemical names.

### DESCRIPTION OF THE RELATED ART

Multiple methods for naming chemical substances coexist at present, including IUPAC nomenclature, CAS number, chemical formula, SMILES, International Chemical Identifier, and so on. Among them, IUPAC nomenclature is specified by the International Union of Pure and Applied Chemistry (IUPAC), defining chemical terms in various aspects ranging from organics to non-organics and from macro-molecules to micro-molecules. IUPAC nomenclature is widely applied in chemical documents, patent specifications, manuals, and textbooks. An example IUPAC name is 4-(aminomethyl)cyclohexane-1-carboxylic acid. The structure of the chemical is shown in FIG. 4. A chemical formula is a formula that combines element symbols to represent the composition of a substance, including an elementary substance and a chemical compound. The chemical formula represents a pure substance only, and a mixture has no chemical formula, such as C8H15NO2. SMILES (simplified molecular input line entry specification) is a specification that unambiguously describes the structure of molecules using ASCII strings, such as C1CC(CCC1CN)C(=0)0. InChI (International Chemical Identifier), jointly designed by IUPAC and NIST (National Institute of Standards and Technology) is a string for uniquely identifying chemical compound IUPAC names, such as InChI=1S/C8H15NO2/c9-5-6-1-3-7(4-2-6)8(10)11/h6-7H,1-5,9H2,(H,10,11).

With the fast development of information technology in the past few decades, more and more computer aiding applications are developed to help to process chemical data. For example, OCR (Optical Character Recognition) is used to scan the hard copy documents and save them in digital format; NER (Named Entity Recognition) is used to automatically identify chemical names from documents. Search engines help to retrieve documents containing relevant chemical names. These approaches are of great importance in helping people to process chemical information.

In reality, however, more new approaches are needed to help to process various chemical documents. One of them is to help users to input, use or check chemical names with editing tools. Taking IUPAC chemical names for an example, most IUPAC names are quite long and difficult to spell such that even the most experienced experts may make mistakes. Therefore, an automatic chemical name checking application is of great necessity. Nowadays general document processing tools, such as Microsoft™ Word and Lotus™ Sympathy, are used to edit chemical documents, whereas they cannot be used to process chemical names.

Existing spell checking approaches in NLP (natural language processing) technologies can be categorized into two types. One is editing distance based, which searches for the most similar names (i.e. the shortest editing distance) in a dictionary for best replacements. The editing distance algorithm is a method for measuring the similarity between two strings that counts the smallest number of characters that are inserted, deleted or replaced for changing from one string to another. For example, the editing distance between “three” and “tree” is 1, only one character “h” needs to be deleted in order to make these two strings the same. The other approach is pronunciation based, which searches for the name with the most similar pronunciation for replacement. The pronunciation-based spelling check corrects spelling errors based on the similarity of pronunciation. For example, users may misspell “wrench” as “rench,” because “w” is silent. The pronunciation-based spelling check will correct “rench” as “wrench.” However, it is a pity that neither of these two approaches is suitable for checking chemical names.

### SUMMARY OF THE INVENTION

According to one aspect of the present invention, a method is provided for checking a chemical name, which comprises: tokenizing the chemical name and checking the chemical name according to chemical associations between chemical compositions represented by the tokens.

According to another aspect of the present invention, a system is provided for checking a chemical name, which comprises: a tokenizer configured to tokenize the chemical name and a checker configured to check the chemical name according to chemical associations between chemical compositions represented by the tokens.

By providing a method and system for checking a chemical name, the present invention can not only help a user to find and correct errors in spelling a chemical name but also check the entire chemical name at the level of chemical associations. Hence, not only chemical names that are not correctly spelled but also ones that do not conform to chemical rules can be found, and significant help is provided to users for correcting chemical names.

### BRIEF DESCRIPTION OF THE DRAWINGS

To explain the features and advantages of embodiments of the present invention in detail, reference is made to the following figures. If possible, like or similar reference numerals are used to designate the same or similar parts throughout the figures and description, wherein:

FIG. 1 shows an embodiment of a method for checking a chemical name of the present invention;

FIG. 2 shows a flowchart of checking the valence;

FIG. 3 shows another embodiment of a method for checking a chemical name of the present invention;

FIGS. 4 and 5 show instances of checking a concrete chemical name of the present invention; and

FIG. 6 shows a block diagram of a system for checking a chemical name of the present invention.

### DETAILED DESCRIPTION OF THE PREFERRED EMBODIMENT

A detailed description is given below with reference to exemplary embodiments of the present invention, and examples of the embodiments are illustrated in the figures, where like reference numerals denote the same elements. This present invention is not limited to the disclosed exemplary embodiments, and not every feature of the method and device is essential to the implementation of the present invention as claimed in any claim. Throughout the disclosure, moreover, when depicting or describing a method or processing, steps of the method may be performed in any order or at the same time, unless it is clear from the context that a step depends on a previous step. Furthermore, there may be an obvious time interval between steps.

The chemical compositions of a chemical substance can conform to multiple chemical associations, which are subjected to natural laws, e.g. valences. The valence refers to the number of monovalent atoms (e.g. hydrogen atoms and chlorine atoms) that can be joined by an atom or a structural segment as much as possible, or the number of monovalent atoms (e.g. hydrogen atoms and chlorine atoms) that can be replaced. For example, the valence of hydroxyl is −1, because hydroxyl can join at most one hydrogen atom to form a water molecule. The chemical name segments of a chemical name should comprise both positive-valence segments and negative-valence segment, only positive-valence segments or negative-valence segments are not allowed, and the sum of valences of all chemical name segments is close or equal to 0. For an organic chemical compound, its valence is related to position information. For a dimethyloctane or cycloalkyl organic substance, the sum of chemical bond values of molecular segments joined by a carbon atom at the beginning or end should not be larger than 3 and should not be larger than 2 at other positions. Take the chemical name 3-bromo-2-chloro-5-ethyl-4,4-dimethyloctane for example. The chemical segment dimethyloctane has substituents with a hydrogen atom at 3 positions (bromo at position 3, chloro at position 2, ethyl at position 5). The original valence is 0, and then 3 is subtracted from 0 to obtain a valence of −3, which is used as the valence of this chemical segment. By utilizing this natural law of chemical substances, it is possible to check chemical names. Considering the popularity of IUPAC nomenclature, a detailed description is given below to concrete embodiments of the present invention in the context of IUPAC nomenclature. The present invention utilizes both a check correction method in natural language processing and an instinct chemical association of a chemical substance, e.g. the valence rule in chemical names. This property may be expanded to SMILES, INCHI, and other nomenclature checks. For example, regarding the set value of a valence of each atom, it is checked whether the sum of valences of all atoms is 0 or not; if not, the name is invalid. In addition, although a check is performed below with respect to the law between valences of chemical substances, any proper chemical association of chemical substances applies to the check of the present invention. For example, regarding a dimethyloctane or cycloalkyl organic substrates, the number of molecular segments joined by the carbon atom at the beginning or end should not be larger than 3 and should not be larger than 2 at other positions.

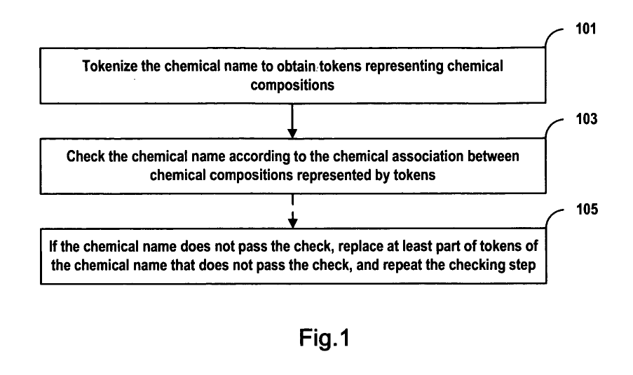

Referring to FIG. 1, this figure depicts a first embodiment of a method for checking a chemical name of the present invention. In step 101, a chemical name is tokenized to obtain tokens representing chemical compositions. During tokenizing the chemical name, the chemical name may be separated into chemical name tokens using a regular expression summarized by tokenization on the basis of nomenclature. An example of a regular expression summarized on the basis of IUPAC nomenclature is shown as follows: (\n), (;)[a-zA-Z0-9\s], ester(\s), urea(.), amide(,), imide(,), methanone(\s), butanonone(\s), propanone(\s), one(Ns)[0-9], ol(\s), ol(,\s)[̂\s], ile(\s), (,)[a-z][a-z], [a-zA-Z](,\s)[̂\s], (\s)mono, (\s)di, (\s)tri, (\s)tetra, (\s)penta, (\s)hexa, (\s)hepta, (\s)octa, (\s)nona, (\s)deca, (\t), . . . . In the regular expression, portions placed within parentheses are separators, which are not included in chemical name segments. Regarding 4-(aminomethyl)cyclohexane-1-carboxylic acid, for example, the regular expression summarized as such will become the following tokens after being tokenized: aminomethyl, cyclohexane and carboxylic, wherein each token represents a corresponding chemical composition, and acid will be omitted because it is generally used as a stop word.

In step 103, the chemical name is checked according to the chemical association between chemical compositions represented by tokens. Chemical compositions represented by tokens have certain chemical association, which may be association of valence or other chemical association between respective chemical compositions, for example whether the binding position is proper, whether relevant chemical compositions can coexist, and the like. Based on the present invention, those skilled in the art may conceive various proper applicable chemical associations to implement the present invention, by utilizing the chemical association rule between chemical compositions in the chemical field. If the chemical association between chemical compositions represented by tokens is correct, it is then determined that the chemical name is correct and passes the check. On the contrary, if the chemical association between chemical compositions represented by tokens does not conform to the relevant natural law, it is then determined that the chemical name is not correct and does not pass the check. To judge the chemical association between chemical compositions, relevant constraint rules that conform to the natural law may be set in advance. Hence, the check then becomes examining whether the chemical association between chemical compositions represented by tokens of a chemical name under test conforms to these rules. Of course, those skilled in the art may design various applicable constraint rules according to their own common technical knowledge on the basis of the present application. At this point, the check result of the chemical name is rendered to the user for reference.

Preferably (though not essential to the solution of the inventive problem), the method further comprises step 105. In step 105, if the chemical name does not pass the check, at least a part of tokens of the chemical name that does not pass the check is replaced, and the foregoing checking steps are repeated. The relevant chemical name may be tokenized to corresponding tokens by the above-discussed tokenization on the basis of existing chemical name dictionaries, (e.g. PubChem) that provides information on a large amount of chemical substances, including various names (IUPAC, Smile, etc.). Preferably, these tokens are stored to form a chemical name token dictionary, one entry of which may be “monoxide”, for example. A token is selected according to tokens generated on the basis of a chemical name dictionary or according to a chemical name token dictionary to replace the token that does not pass the check. Then, the foregoing checking steps are repeated in order to obtain a chemical name that passes the check. Preferably, an index may be created for the chemical name token dictionary by using an inverted list according to a chemical name token, other chemical name tokens which occur in a chemical name together with the chemical name token, and the number of co-occurrences, so that the speed of reading replacement tokens may be enhanced, and the efficiency of checking chemical names may be improved and optimized. The inverted list is an existing indexing method, which is used by creating a mapping to storage positions of a certain word in a document or a set of documents under full-text search. Here, a chemical name token corresponds to names of all tokens that appear together with this token and to the number of co-occurrences. Of course, those skilled in the art may employ another sort order or other existing order to create an index.

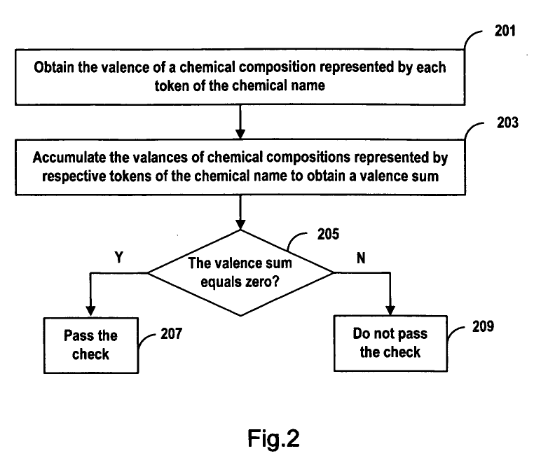

FIG. 2 shows a preferred embodiment of checking a valence. In step 201, the valence of a chemical composition represented by each token of a chemical name is obtained. Various approaches may be taken for obtaining the valence of a chemical composition represented by a token, and a token valence dictionary for each chemical name token and its corresponding valence may be generated. This dictionary may be either compiled manually or generated semi-automatically. For example, starting from a seed dictionary that comprises a small portion of chemical name segments and chemical bond values, it proceeds to process tokens in a large amount of chemical names. If the valence of only one token is unknown, the chemical bond value of the unknown token can be obtained by utilizing the characteristic that the sum of valences of a chemical name is 0, so that the number of seed dictionaries is enlarged. In turn, the number of chemical name tokens in seed dictionaries is continuously enlarged using an iterative method, so that a relatively complete token valence dictionary can be obtained. One entry of the token valence dictionary may be dinitrogen, +2, +10. In step 203, valences of chemical compositions represented by all of the tokens of the chemical name are accumulated to obtain a valence sum. Besides, if the valence of the chemical composition is related to the position, the dictionary records an initial valence of this chemical composition, and the valence of the chemical composition is judged in conjunction with the position information in the chemical name during practical comparison. In step 205, it is judged whether the obtained valence sum is zero or not. If yes, then it is determined in step 207 that the chemical name passes the check; if not, then it is determined in step 209 that the chemical name to which the token belongs does not pass the check.

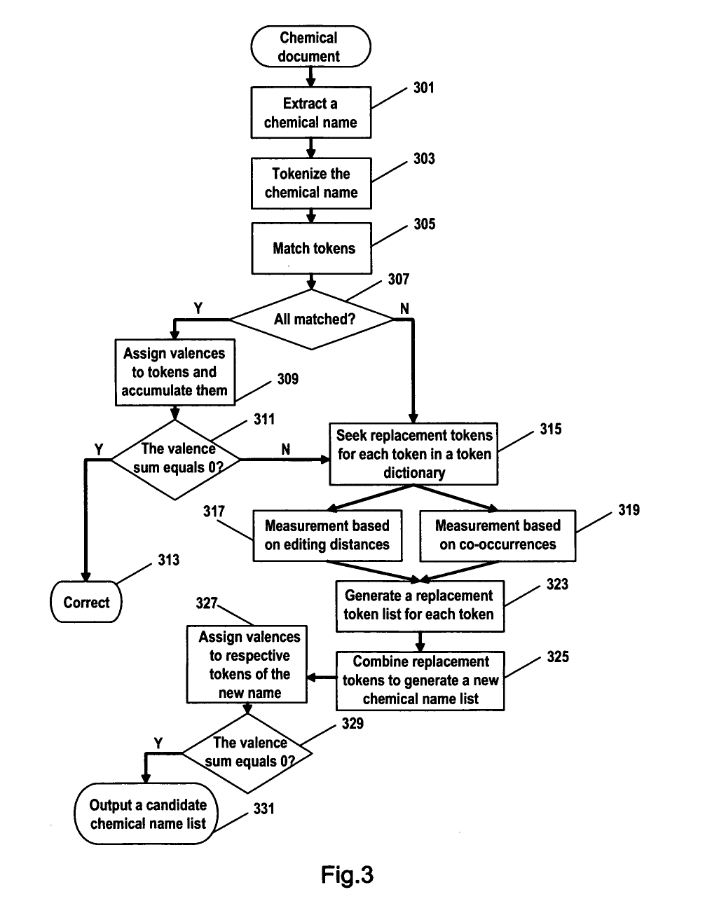

FIG. 3 shows another more preferred embodiment of the present invention. What should be explained is that the chemical association employed in this preferred embodiment is the association between valences for the purpose of simplicity, whereas it does not mean to limit the chemical association of the present invention to the association between valences. This is only a preferred embodiment of the present invention. Selecting the association between valences has some advantageous effects, i.e. convenient implementation and high efficiency. Different from other automatic error correction methods understood in natural language, using the association between valences may utilize the internal structure of a chemical substance and thus produce the check effect which conforms to the natural law.

In step 301, the chemical name is automatically extracted from a document. The document may be a patent, a manual, and any other unstructured textual data or structured data. Automatic extraction may utilize a rule-based or machine learning-based method. A rule-based method summarizes prefixes, postfixes and other strings with a high frequency of occurrence, which are widely used by chemical names, utilizes these features to judge whether a word is a chemical name, and differentiates this word from other adjacent words. A machine learning-based method utilizes annotated samples to train models that can automatically annotate chemical names. An order statistics model is relatively common, such as HMM (Hidden Morkov Model), MeMM (Maximum Entropy Markov Model), CRF (Conditional Random Field), etc. There already exist many methods for extracting a particular type of word from unstructured textual data or structured data, and details thereof are omitted here.

In step 303, the extracted chemical name is tokenized using the above-discussed regular expression and tokenization. In step 305, all tokens of the chemical name are queried and checked according to the above chemical name token dictionary. If each token of the chemical name is matched to an identical token in the token dictionary, the flow goes to step 309. In step 309, a corresponding valence is assigned to each token of the chemical name according to the token valence dictionary. In some cases, one token may have multiple valences. In step 311, judgement is made as to whether the sum of valences of all tokens of a chemical name is 0 or not. If yes, the flow goes to step 313 in which the chemical name is determined as a correct chemical name and the check on the chemical name ends. If no composition has a sum equaling 0, the flow then goes to step 315 in which the current chemical name is checked and corrected. Steps 305, 309, 311, and 313 help to quickly separate a correct chemical name without a subsequent calculation of high-order complexity, thereby achieving notable technical effect. Preferably, before the chemical name is tokenized, the whole name may be subjected to a spelling examination according to the chemical name dictionary, so as to further filter a correct chemical name and reduce the computation workload.

If it is found in step 305 that one or more tokens are not fully matched, the flow then goes to step 315. In step 315, a proper replacement token is sought for at least one token of the chemical name according to the chemical name token dictionary. Preferably, proper replacement tokens are sought for all tokens. Seeking a proper replacement token includes two aspects of measurements. For example, a measurement is performed using an editing distance as shown in step 317. That is, all tokens in the token repository are scored with respect to editing distances to the current token; the shorter an editing distance, the higher a score. For example, the editing distance from cyclobutane to cyclooctane is 2, and the editing distance to cyclopropan is 3, so cyclooctane is preferably selected as a replacement. Alternatively, a measurement is performed using the number of co-occurrences as shown in step 319, which uses adjacent tokens to the current token in the chemical name and calculates the number of co-occurrences of these adjacent tokens and tokens in the chemical name token dictionary. The larger the number of co-occurrences, the higher a score is. Take “dinitrogen monoxide” for example, if “monoxide” is to be replaced, it is found that the number of co-occurrences of “pentoxide” and “dinitrogen” is relatively large, so “pentoxide” can be a candidate replacement for “monoxide”. As discussed above, tokens with a large number of co-occurrences may be provided in the chemical name token dictionary.

In step 323, all tokens in the chemical name token dictionary are ranked in consideration of these two measurements, and a token in a high rank is used as a replacement token of this token. It should be noted that not all tokens of the checked chemical name need to be replaced. It should be noted that steps 317 and 319 are parallel, and only one of them, and preferably the combination thereof, may be performed. By using the combination, it is possible to correct types of errors at the same time and provide users with more accurate recommendations.

In step 323, a replacement token list is generated for each token according to the above recommended replacement tokens. In step 325, replacement tokens of all tokens and not yet replaced tokens (if any) are combined to form an error correction list of candidate chemical names for the chemical name. For each candidate chemical name, a corresponding valence is assigned to a token of each chemical name in step 327, and the sum of valences is examined in step 329. If the sum equals 0, then it is used as a possible result of the check and correction process and is finally outputted to the user. Preferably, multiple chemical names are ranked in order to be recommended to the user. More preferably, a chemical name that passes the check and that is formed by tokens with a high frequency of co-occurrences in the chemical name token dictionary is preferably recommended to the user.

As a variation of the above embodiment, not multiple or all replacement combinations are provided at a time, but only one or several replacement combinations are provided for the check on the chemical association. If these replacement combinations fail to pass the check, other replacement combinations are then provided. More preferably, a replacement combination formed by tokens with a high frequency of co-occurrences in the chemical name token dictionary is first subjected to the check. If it passes the check, it is then recommended to the user preferably; otherwise other replacement combinations are provided. All alternatives which those skilled in the art may conceive based on the present invention should fall within the protection scope of the present invention.

The process of checking the chemical name “dinitrogen monoxide” (N₂O) will be used below for illustrating the inventive method for checking a chemical name. First of all, the chemical name “dinitrogen monoxide” is tokenized into two tokens, namely “dinitrogen” and “monoxide”. Then, the tokens are sent to a spelling checker based on existing chemical name token dictionary. That is, it is checked whether each token occurs in the chemical name token dictionary. The check results in that both “dinitrogen” and “monoxide” occur in the chemical name token dictionary. Thus, a possible chemical bond value of each chemical name token is obtained through search with the valence value index list, i.e. dinitrogen (+2, +10) and monoxide (−2). Possible valence sums of 0 and 8 are obtained by accumulating possible chemical bond values of dinitrogen(+2, +10) and monoxide(−2). Since a possible valence sum equals 0, it is determined that dinitrogen monoxide is a valid chemical name, and then the check on the chemical name dinitrogen monoxide is completed.

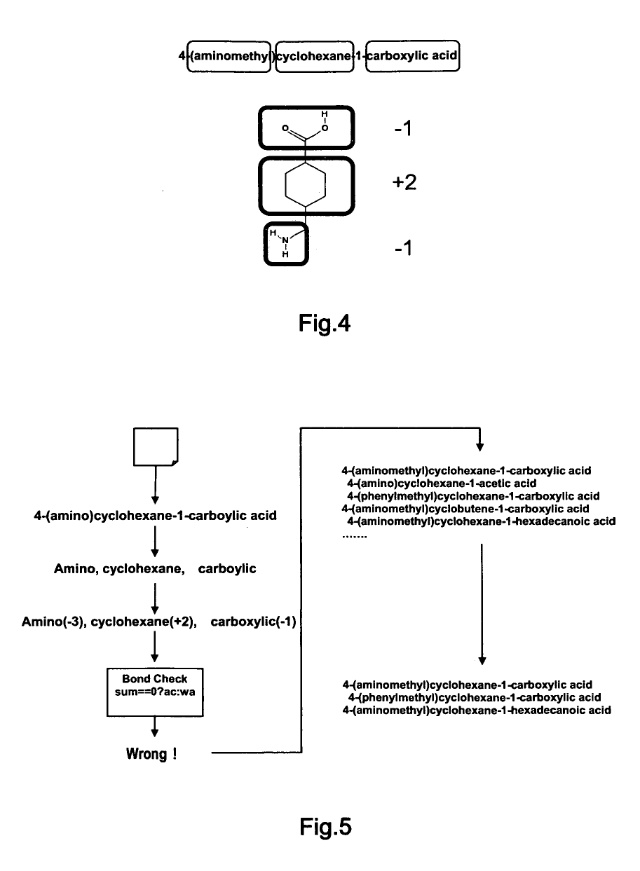

FIG. 4 shows the molecular structure and valence of a correct chemical name, “4-(aminomethyl)cyclohexane-1-carboxylic acid”, and FIG. 5 shows an example of how to check a wrong chemical name, “4-(amino)cyclohexane-1-carboylic acid”. The chemical name 4-(amino)cyclohexane-1-carboylic acid is first tokenized to “amino”, “cyclohexane”, and “carboylic” according to the tokenization. Then, the tokens are examined using the editing distance algorithm according to the chemical name dictionary or chemical name token dictionary. It is found that the token “carboylic” should be “carboxylic”. It is examined whether each token occurs in the chemical name token dictionary or not. If yes, valence values Amino(−3), carboxylic(−1) corresponding to respective tokens are obtained according to the token valence dictionary. In view of the token valence dictionary and binding position information 4, 1, a result is obtained that the valence of cyclohexane is +2, leading to a non-zero valence sum, so it is determined that the chemical name 4-(amino)cyclohexane-1-carboylic acid is a wrong chemical name. Then, replacement segments are found for each chemical name segment according to the chemical name token dictionary and are recombined to obtain a set of new chemical names, for example:
1. 4-(aminomethyl)cyclohexane-1-carboxylic acid
2. 4-(amino)cyclohexane-1-acetic acid
3. 4-(phenylmethyl)cyclohexane-1-carboxylic acid
4. 4-(aminomethyl)cyclobutene-1-carboxylic acid
5. 4-(aminomethyl)cyclohexane-1-hexadecanoic acid

For these chemical names, a chemical bond value is reassigned to each segment according to the token valence index dictionary and is reexamined. As a result, it is found that “4-(aminomethyl)cyclohexane-1-carboxylic acid”, “4-(phenylmethyl)cyclohexane-1-carboxylic acid”, and “4-(aminomethyl)cyclohexane-1-hexadecanoic acid” are valid and are provided to the user for error correction reference after being ranked according to frequencies of co-occurrences.

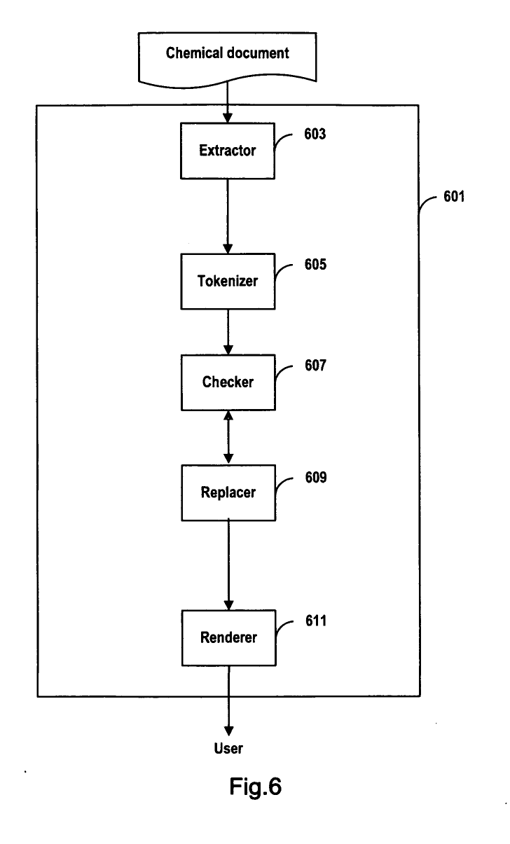

FIG. 6 shows a chemical name check system 601. The chemical name check system 601 comprises: a tokenizer 605 configured to tokenize a chemical name to obtain tokens representing chemical compositions; and a checker 607 configured to check the chemical name according to the chemical association between chemical compositions represented by tokens. Preferably, the chemical name check system 601 may further comprise a replacer 609 configured to, if a chemical name does not pass the check, replace at least part of tokens of the chemical name that does not pass the check, and instruct the checker to check the replaced chemical name. Preferably, the replacing of tokens of the chemical name that does not pass the check comprises obtaining tokens according to a chemical name token dictionary so as to replace at least part of tokens of the chemical name that does not pass the check. Preferably, the chemical name check system 601 further comprises an extractor 603 configured to extract a chemical name from a chemical document. Preferably, the checker 607 is provided with means at the front end for examining the spelling of a token according to the chemical name token dictionary. Preferably, nomenclature for the chemical name is IUPAC nomenclature, and the chemical association between chemical compositions represented by the tokens refers to the association between valences of chemical compositions.

Preferably, the checker 607 further comprises means for obtaining the valence of a chemical composition represented by a token. Preferably, the means for obtaining the valence of a chemical composition represented by a token comprises: a component for obtaining the valence corresponding to each token of the chemical name according to a token valence dictionary; means for accumulating the valences of chemical compositions represented by respective tokens of the chemical name to obtain a valence sum; means for judging whether the valence sum equals zero or not; and means for, if the valence sum does not equal zero, determining the chemical name to which the tokens belong does not pass the check.

Preferably, an index is created for the chemical name token dictionary by using an inverted list according to a token of the chemical name, other chemical name tokens which occur in a correct chemical name together with the token of the chemical name, and the number of co-occurrences. The obtaining of tokens according to the chemical name token dictionary in order to replace the token of the chemical name that does not pass the check comprises selecting replacement tokens according to the chemical name token dictionary based on at least one of the measurement of editing distances of tokens and the measurement of numbers of co-occurrences of tokens.

Preferably, the chemical name check system 601 further comprises a renderer 611 configured to recommend to the user chemical names which pass the check and which are formed by tokens with a larger number of co-occurrences in the chemical name token dictionary preferably, based on multiple chemical names which pass the check and which are obtained from multiple replacement combinations formed by multiple replacement tokens provided by the replacer 609. Alternatively, the selection may be automatically done based on the ranking of the candidate names.

Components of the chemical name check system 601 and their mutual connections have been described in detail. Since a method for implementing each component has been described in detail in multiple embodiments of the method of the present invention, details thereof are omitted.

By providing a method and system for checking a chemical name, the present invention can not only help users to find and correct errors in spelling a chemical name but also check the entire chemical name at the level of chemical associations. Hence, not only chemical names that are not correctly spelled but also ones that do not conform to chemical rules can be found, and significant help is provided to users for correcting chemical names. Therefore, notable technical effect is achieved.

In addition, the method for protecting user information according to the present invention may be implemented by means of a computer program product. The computer program product comprises a code portion executed for implementing the simulation method of the present invention when the computer program product is running on a computer.

The present invention may further be implemented by recording a computer program in a computer-readable medium. The computer program comprises a software code portion executed for implementing the simulation method of the present invention when the computer program is running on a computer. That is, the process of the simulation method according to the present invention can be distributed in the form of instructions stored at a computer-readable medium or in other form, regardless of the particular type of a medium that performs the distribution. Examples of the computer-readable medium comprise media such as EPROM, ROM, magnetic tapes, paper, floppy disks, hard disk drives, RAM, and CD-ROM, as well as transmission-type media like digital and analog communication links.

Although the present invention has been presented and described with reference to the preferred embodiments of the present invention, those skilled in the art would readily appreciate that various formal and detailed modifications may be made without departing from the spirit and scope of the present invention as defined by the appended claims.

What is claimed is:

1. A computer-implemented method for automatically checking a chemical name, the method comprising:
tokenizing the chemical name to obtain tokens representing chemical compositions; and
checking the chemical name according to a chemical association between chemical compositions represented by the tokens.

2. The method of claim 1, further comprising:
if the chemical name does not pass the checking step, replacing at least part of tokens of the chemical name that does not pass, and repeating the checking step.

3. The method of claim 1, wherein nomenclature of the chemical name is IUPAC nomenclature.

4. The method of claim 1, wherein the chemical association between chemical compositions represented by the tokens includes the association between valences of chemical compositions.

5. The method of claim 4, wherein checking the chemical name according to the chemical association between chemical compositions represented by the tokens further comprises:
obtaining a valence of a chemical composition represented by each token of the chemical name;
accumulating valances of chemical compositions represented by respective tokens of the chemical name to obtain a valence sum;
judging whether the valence sum equals zero or not to determine whether the chemical name passes the checking.

6. The method of claim 2, wherein replacing at least part of tokens of the chemical name that does not pass the checking comprises:
obtaining tokens according to a chemical name token dictionary so as to replace at least part of tokens of the chemical name that does not pass the check.

7. The method of claim 6, wherein an index is created for the chemical name token dictionary by using an inverted list according to a token of the chemical name, other tokens which occur in a correct chemical name together with the token of the chemical name, and a number of co-occurrences.

8. The method of claim 6, wherein obtaining tokens according to a chemical name token dictionary so as to replace at least part of tokens of the chemical name that does not pass the checking comprises:
selecting replacement tokens according to the chemical name token dictionary based on at least one of the measurement of editing distances of tokens and the measurement of numbers of co-occurrences of tokens.

9. The method of claim 8, further comprising:
providing multiple replacement tokens for forming multiple replacement combinations in order to obtain multiple chemical names that pass the checking;
preferably recommending to a user chemical names that pass the checking and that are formed by tokens with a larger number of co-occurrences in the chemical name token dictionary, according to the obtained multiple chemical names that pass the checking.

10. The method of claim 5, wherein obtaining the valence of a chemical composition represented by each token of the chemical name comprises:
obtaining a valence corresponding to a token according to a token valence dictionary.

11. The method of claim 1, wherein the spelling of a token is examined prior to checking the chemical name according to the chemical association between chemical compositions represented by tokens.

12. A system for checking a chemical name, comprising:
a tokenizer configured to tokenize the chemical name to obtain tokens representing chemical compositions; and
a checker configured to check the chemical name according to a chemical association between chemical compositions represented by the tokens.

13. The system of claim 12, further comprising:
a replacer configured to, if the chemical name does not pass the check, replace at least part of tokens of the chemical name that does not pass the check, and instruct the checker to check the chemical name after the replacement.

14. The system of claim 12, wherein nomenclature of the chemical name is IUPAC nomenclature.

15. The system of claim 12, wherein the chemical association between chemical compositions represented by the tokens includes the association between valences of chemical compositions.

16. The system of claim 15, wherein the checker further comprises:
means for obtaining a valence of a chemical composition represented by each token of the chemical name;
means for accumulating valances of chemical compositions represented by respective tokens of the chemical name to obtain a valence sum;
means for judging whether the valence sum equals zero or not to determine whether the chemical name to which the token belongs passes the check.

17. The system of claim 13, wherein the replacer for replacing at least part of tokens of the chemical name that does not pass the check is adapted for:
obtaining tokens according to a chemical name token dictionary so as to replace at least part of tokens of the chemical name that does not pass the check.

18. The system of claim 17, wherein an index is created for the chemical name token dictionary by using an inverted list according to a token of the chemical name, other tokens which occur in a correct chemical name together with the token of the chemical name, and a number of co-occurrences.

19. The system of claim 17, wherein obtaining tokens according to a chemical name token dictionary so as to replace at least part of tokens of the chemical name that does not pass the check comprises:
selecting replacement tokens according to the chemical name token dictionary based on at least one of measurement of editing distances of tokens and measurement of numbers of co-occurrences of tokens.

20. The system of claim 19, further comprising:
a renderer configured to provide multiple replacement tokens for forming multiple replacement combinations in order to obtain multiple chemical names that pass the check, and recommend to a user chemical names that pass the check and that are formed by tokens with a larger number of co-occurrences in the chemical name token dictionary.

21. The system of claim 16, wherein the means for obtaining the valence of a chemical composition represented by each token of the chemical name comprises:
a component for obtaining a valence corresponding to a token according to a token valence dictionary.

22. The system of claim 12, further comprising:
an extractor configured to extract a chemical name from a chemical document.

23. The system of claim 12, wherein means for examining the spelling of a token according to the chemical name token dictionary is placed at the front of the checker.
